(19) United States
(12) Patent Application Publication
(10) Pub. No.: US 2012/0169914 A1
(43) Pub. Date: Jul. 5, 2012

(54) METHOD TO ENLARGE AND CHANGE DISPLAYED IMAGE AND PHOTOGRAPHING APPARATUS USING THE SAME

(75) Inventors: Byoung-woo KIM, Seoul (KR); In-ho Kim, Suwon-si (KR); Seung-ho Lee, Suwon-si (KR); Young-hoon Kim, Seoul (KR); Ho-jung Lee, Seoul (KR)

(73) Assignee: Samsung Electronics Co., Ltd, Suwon-si (KR)

(21) Appl. No.: 13/420,861

(22) Filed: Mar. 15, 2012

Related U.S. Application Data
(63) Continuation of application No. 12/649,432, filed on Dec. 30, 2009.

(30) Foreign Application Priority Data
Jan. 8, 2009 (KR) 2009-0001494

(51) Int. Cl. H04N 5/225; G09G 5/00; G09G 5/373

(52) U.S. Cl. 348/333.12; 345/671; 345/619; 348/E05.024

(57) ABSTRACT

A method to enlarge and change an image displayed by a photographing apparatus, and a photographing apparatus using the same. The enlargement method includes adding guide information regarding a zoom-in area and compensating the guide information based on the zoom-in command.

### CROSS-REFERENCE TO RELATED APPLICATIONS

This application is a Continuation Application of prior application Ser. No. 12/649,432 filed on Dec. 30, 2009 in the United States Patent and Trademark Office, which claims the benefit under 35 U.S.C. §119(a) of Korean Patent Application No. 2009-1494, filed on Jan. 8, 2009, in the Korean Intellectual Property Office, the contents of which are incorporated herein by reference in its entirety.

### BACKGROUND

1. Field of the Invention

The present general inventive concept relates to a method to enlarge and change a displayed image, and a photographing apparatus using the same, and more particularly, to a method to enlarge a selected area of a displayed image and a method to change an enlarged image to indicate the selected area, and a photographing apparatus using the same.

2. Description of the Related Art

As photographing apparatuses such as digital cameras and camcorders have become widespread and mobile communication terminals having a photographing apparatus have become widely used, photographs of images have become increasingly easy to capture. As the quality of photographing apparatuses has been greatly improved along with the popularization of the photographing apparatuses, the photographing apparatuses are capable of zooming in on an object up to 50 times, and provide a user with an enlarged photographable image displayed on a display screen of the photographing apparatus.

However, since available zoom-in ratio is increased, it is difficult for a user to easily search for an object which he or she desires to enlarge. This problem occurs when an object is not placed at the center of an optical axis, and the problem is exacerbated by hand-shaking caused by zoom-in or zoom-out or other camera work such as panning and tilting.

Accordingly, a method to easily search for an object to be enlarged is desired.

### SUMMARY

Example embodiments of the present general inventive concept provide a method to enlarge and change an image displayed by a photographing apparatus in response to a zoom-in so that a user may easily search for the object the user desires to be enlarged, and a photographing apparatus using the same.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a method to enlarge an image displayed by a photographing apparatus, the method including if a zoom-in area is designated on the image, adding guide information regarding the zoom-in area to the image, if a zoom-in command is input, enlarging the image and compensating the guide information in response to the zoom-in command.

The compensating of the guide information may include enlarging the guide information according to a zoom-in ratio corresponding to the zoom-in command.

The method may further include, if an optical axis of the photographing apparatus is changed, compensating the guide information based on information regarding the changed optical axis.

The information regarding the changed optical axis may include tilting information, panning information, hand-shaking information, or any combination thereof.

The compensating the guide information may include combining the information regarding the changed optical axis with a zoom-in ratio corresponding to the zoom-in command.

The method may further include storing an image to which the guide information is added, wherein the compensating the guide information may include matching a portion of the stored image with the enlarged image.

The compensating the guide information may include reducing or enlarging at least one of the enlarged image and the stored image and matching the enlarged image with the portion of the stored image; and compensating the guide information to display guide information proportional to the guide information displayed on the portion of the stored image on the enlarged image.

The guide information may include a plurality of concentric circles of which the center is the zoom-in area, an indicator indicating the zoom-in area, or a combination thereof.

The foregoing and/or other features and utilities of the present general inventive concept may also be achieved by providing a method to change an image displayed by a photographing apparatus, the method including adding guide information regarding an area indicated on the image; and changing the screen and compensating the guide information using information regarding horizontal movement, vertical movement, or a combination thereof.

The information regarding horizontal movement may include information regarding movement of the photographing apparatus that is parallel to a display screen of the photographing apparatus generated by tilting, panning, hand-shaking, or any combination thereof, and the information regarding vertical movement may include information regarding movement that is vertical to the display screen generated by at least one of zoom-in and zoom-out.

The foregoing and/or other features and utilities of the present general inventive concept may also be achieved by providing a photographing apparatus, including a display unit to display an image; and a controlling unit to add guide information regarding a zoom-in area to the image if the zoom-in area is designated on the image, and to enlarge the image and compensate the guide information in response to a zoom-in command being input.

The controlling unit may enlarge and compensate the guide information according to a zoom-in ratio corresponding to the zoom-in command.

The photographing apparatus may further include a motion sensor to sense whether an optical axis of the photographing apparatus is changed, wherein the controlling unit compensates the guide information based on information regarding the changed optical axis.

The information regarding the changed optical axis may include tilting information, panning information, hand-shaking information, or any combination thereof.

The controlling unit may compensate the guide information by combining the information regarding the changed optical axis with a zoom-in ratio corresponding to the zoom-in command.

The photographing apparatus may further include a storage unit to store an image to which the guide information is added, wherein the controlling unit compensates the guide information by matching a portion of the stored image with the enlarged image.

The photographing apparatus may further include an image processing unit to reduce or enlarge at least one of the enlarged image and the stored image, wherein the controlling unit matches the enlarged image with the portion of the stored image, and displays guide information proportional to the guide information displayed on the portion of the stored image on the enlarged image.

The guide information may include a plurality of concentric circles of which the center is the zoom-in area, an indicator indicating the zoom-in area, or a combination thereof.

The foregoing and/or other features and utilities of the present general inventive concept may also be achieved by providing a photographing apparatus, including a display unit to display an image; and a controlling unit to change the image and compensate guide information regarding an area indicated on the image using information regarding horizontal movement, vertical movement, or a combination thereof.

The information regarding horizontal movement may include information regarding movement of the photographing apparatus that is parallel to a display screen of the photographing apparatus generated by tilting, panning, hand-shaking, or any combination thereof, and the information regarding vertical movement may include information regarding movement that is vertical to the display screen generated by at least one of zoom-in and zoom-out.

The foregoing and/or other features and utilities of the present general inventive concept may also be achieved by providing a method of displaying an image on a photographing apparatus, the method including adding guide information to the image in response to a zoom-in area being designated, the guide information indicating the zoom-in area.

The method may further include enlarging the image in response to a zoom-in command, and compensating the guide information according to the enlarging of the image.

The method may further include compensating the guide information according to movement of the photographing apparatus.

The method may further include forming a first vector from a first optical axis to the zoom-in area in response to the adding of the guide information, and compensating the vector according to a selected zoom-in ratio of the image.

The guide information may be compensated according to the compensation of the first vector.

The method may further include forming a first vector from a first optical axis to the zoom-in area in response to the adding of the guide information, forming a second vector from the first optical axis to a second optical axis in response to movement of the photographing apparatus, forming a difference vector between the first and second vector, and compensating the guide information according to the difference vector.

The method may further include compensating the guide information according to movement of the photographing apparatus.

The foregoing and/or other features and utilities of the present general inventive concept may also be achieved by providing a computer readable medium having recorded thereon a program to cause a computer to perform a method of displaying an image on a photographing apparatus, the method including adding guide information to the image in response to a zoom-in area being designated, the guide information indicating the zoom-in area, and compensating the guide information in response to any changing of the displayed image.

The foregoing and/or other features and utilities of the present general inventive concept may also be achieved by providing a method of displaying an image on a display apparatus, the method including displaying an indicator of a portion of the image in response to the portion being selected, and adjusting the indicator according to any change in the displaying of the image such that at least part of the indicator is displayed after the change.

The indicator may be a plurality of concentric circles having the selected portion of the image as a center point.

The adjusting of the indicator may include enlarging the concentric circles according to an enlargement of the displayed image.

At least a portion of at least one of the concentric circles may be displayed on the enlarged image.

The indicator may be an arrow pointing to the selected portion of the image.

The arrow may extend from an optical axis of the displayed image.

The adjusting of the indicator may include reconfiguring the arrow to extend from a changed optical axis.

The adjusting of the indicator may include enlarging a thickness of the arrow.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is a block diagram illustrating a photographing apparatus according to an exemplary embodiment of the present general inventive concept;

FIG. 2 is a flowchart illustrating a method to compensate guide information according to an exemplary embodiment of the present general inventive concept;

FIGS. 3A to 3D are views illustrating a process of enlarging a displayed image and compensating guide information;

FIG. 4 is a flowchart illustrating a method to compensate concentric circles when a zoom-in command is input;

FIG. 5 is a view in which the first normal vector is extended according to an exemplary embodiment of the present general inventive concept;

FIG. 6 is a flowchart illustrating a method to compensate concentric circles when an optical axis is changed;

FIG. 7 is a view in which a difference vector is generated according to an exemplary embodiment of the present general inventive concept;

FIG. 8 is a view illustrating a relationship between a zoom-in ratio and the second normal vector;

FIG. 9 is a flowchart illustrating a method to compensate concentric circles through image processing;

FIGS. 10A and 10B are views in which concentric circles are compensated by reducing an enlarged image;

FIG. 11 is a view in which concentric circles are compensated using both a normal vector and image processing;

FIG. 12 is a view illustrating a method to enlarge an image using information regarding an arrow guide; and

FIG. 13 is a view in which a thumbnail image is displayed along with a displayed image.

### DETAILED DESCRIPTION OF THE EMBODIMENTS

Reference will now be made in detail to various exemplary embodiments of the present general inventive concept, examples of which are illustrated in the accompanying drawings, wherein like reference numerals refer to the like elements throughout. The embodiments are described below in order to explain the present general inventive concept by referring to the figures.

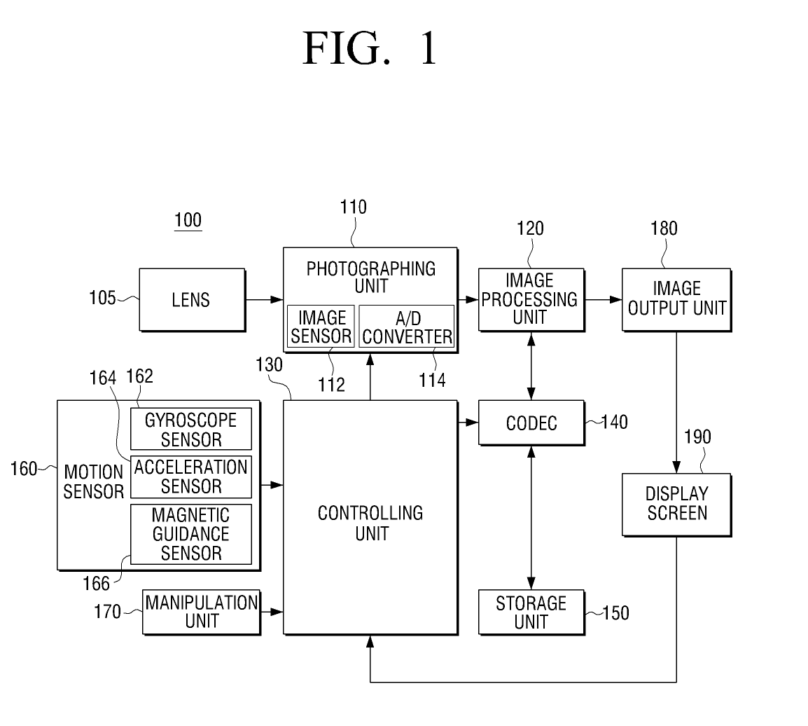

FIG. 1 is a block diagram illustrating a photographing apparatus 100 according to an exemplary embodiment of the present general inventive concept. The photographing apparatus 100 may add guide information regarding a zoom-in area to a displayed image if the zoom-in area is designated on the displayed image, and the photographing apparatus 100 may compensate guide information based on a zoom-in command if the zoom-in command is input.

The guide information may include information which enables a user to be easily aware of a zoom-in area by indicating the zoom-in area. Hereinbelow, a plurality of concentric circles of which the centers are at a zoom-in area will be described as the guide information. An indicator such as an arrow indicating the zoom-in area will also be described as another example of the guide information. It will be understood by those skilled in the art that these are merely two possible examples of the discussed guide information, and that various other types of guide information may be employed individually or in combination according to the present general inventive concept.

The photographing apparatus 100 according to an exemplary embodiment of the present general inventive concept may include a photographing unit 110, a lens 105, an image processing unit 120, a controlling unit 130, a codec 140, a storage unit 150, a motion sensor 160, a manipulation unit 170, an image output unit 180, and a display screen 190.

The display screen 190 of the photographing apparatus 100 may display an image which may be captured and stored by the photographing apparatus 100, such as by a user using the manipulation unit 170. This image may be referred to in the following described embodiments as the displayed image of which an area may be designated to have added thereto the previously described guide information in a zoom-in operation.

The photographing unit 110 may convert an optical signal input received through the lens 105 into an electrical signal, and may process the electrical signal.

The photographing unit 110 performing the above operations may include an image sensor 112 to output an analog image signal and an analog-digital (AD) converter 114 to convert an analog signal into a digital signal. Alternatively, the image sensor 112 and/or AD converter may be provided in the photographing apparatus outside of the photographing unit 110.

The image processing unit 120 may process the signal received from the photographing unit 110. The signal processing may include one or more processes such as a digital zoom, an auto white balance (AWB), an auto focus (AF), an auto exposure (AE), and so on in order to convert a format, adjust an image scale, etc., and may transmit the processed signal to the image output unit 180 which will be described later.

The image processing unit 120 may transmit the processed image signal to the codec 140 to store the photographed image.

The codec 140 may encode an image signal to store the photographed image, and may decode an image signal to display the stored photographed image. In more detail, the codec 140 may encode an image signal received from the image processing unit 120 and transmit the encoded image signal to the storage unit 150, and may decode the encoded image signal stored in the storage unit 150 and transmit the decoded image signal to the image processing unit 120.

The image output unit 180 may output an image signal received from the image processing unit 120 to an internal display apparatus, such as the display screen 190, or to an external output terminal. For example, the image output unit 180 may output the image signal so as to be displayed on the display screen 190 provided in the photographing apparatus 100, a monitor of an externally connected computer, an image processing device, etc.

The storage unit 150 may store an image photographed by the photographing unit 110 in any number of compressed or non-compressed formats, and may store program information and setting information required to control a system of the photographing apparatus 100. The storage unit 150 may be a flash memory, a hard disc, a digital versatile disc (DVD), and so on.

The motion sensor 160 may sense movement of the photographing apparatus 100. The motion sensor 160 may be implemented as a gyroscope sensor 162 to detect rotation of an object, an acceleration sensor 164 to detect acceleration or vibration of an object, etc., or a sensor combining two or more such functions. A magnetic guidance sensor 166 may be added to the motion sensor 160. Although the motion sensor 160 is illustrated in FIG. 1 as comprising the gyroscope sensor 162, acceleration sensor 164, and magnetic guidance sensor 166, it is understood that any one or a combination of these sensors may be included in the motion sensor 160, or may represent the motion sensor 160 itself. However, the motion sensor 160 is not limited to any of these discussed sensors.

The gyroscope sensor 162 may sense rotation of an object (such as the photographing apparatus 100) by detecting whether or not there is angular velocity on two or three axes, and the acceleration sensor 164 may sense movement of an object by detecting whether or not there is acceleration on an x-axis, a y-axis, or a z-axis.

The motion sensor 160 may transmit a signal corresponding to the sensed movement to the controlling unit 130, which will be described later.

The manipulation unit 170 may receive a manipulation command from a user and may transmit the received manipulation command to the controlling unit 130, and the controlling unit 130 may control overall operations of the photographing apparatus 100 according to the user's manipulation command.

The manipulation unit 170 may include a touch pad having buttons to be pressed by the user, a touch screen to receive a touch input from the user, other similar interface elements, or a combination thereof.

In more detail, the controlling unit 130 may control the photographing unit 110 and the image processing unit 120 so as to convert an optical signal into an electrical signal and process the electrical signal, and may control the codec 140 so as to encode the processed image signal and decode the encoded image signal.

Under the control of the controlling unit 130, a zoom-in area may be designated on a displayed image and guide information regarding the zoom-in area may be added to the displayed image in response to the user's command input through the manipulation unit 170. The zoom-in area may be designated by touching a desired area on the display screen 190 displaying the displayed image. In such an exemplary embodiment, the display screen 190 may transmit a signal corresponding to the touch to the controlling unit 130.

The controlling unit 130 may control the displayed image to be enlarged in response to the zoom-in command input through the manipulation unit 170 or the display screen 190, and may control the guide information to be compensated to correspond to the enlarged image. The controlling unit 130 may control the guide information to be compensated according to a changed optical axis using information regarding various movements of the photographing apparatus 100 caused by, for example, hand-shaking detected by the motion sensor 160, camera work such as tilting or panning, etc.

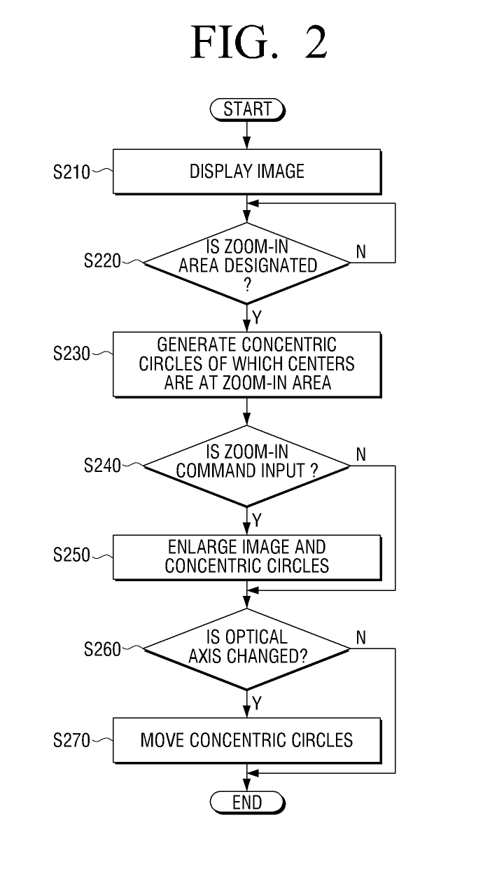

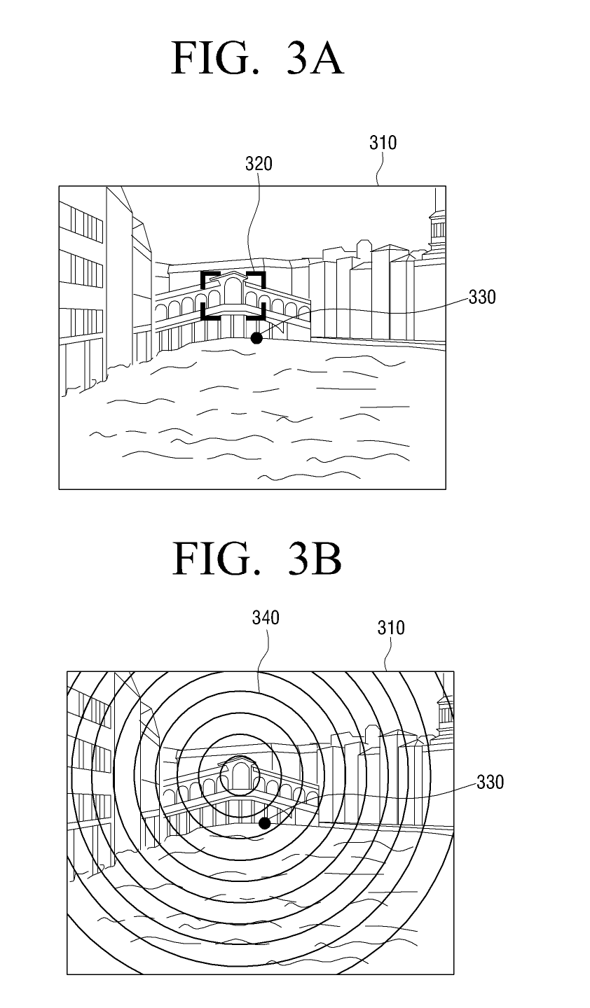

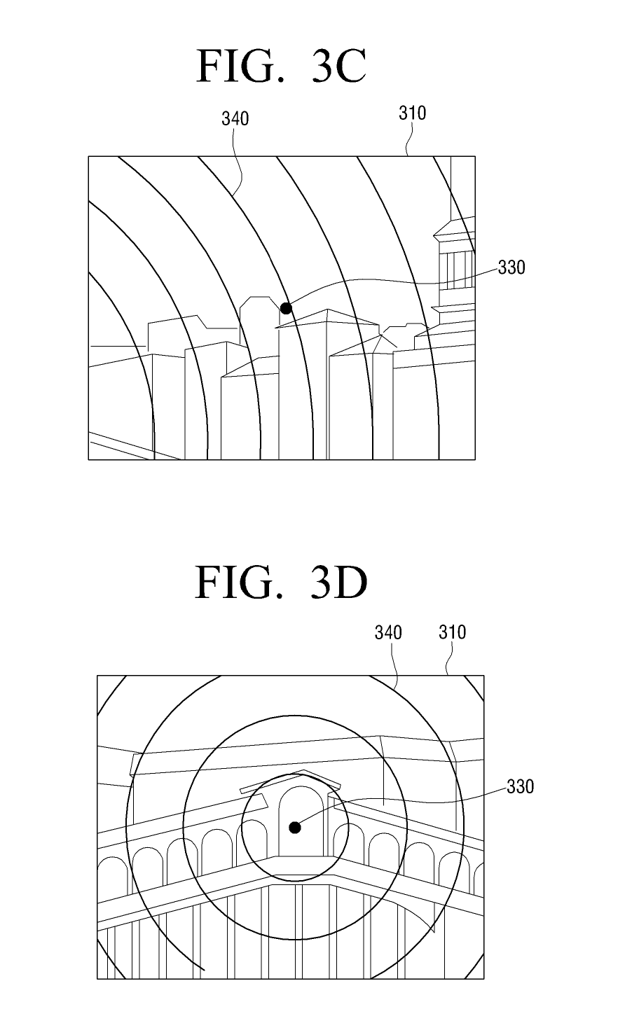

The above operation will be described with reference to FIGS. 2 to 3D. FIG. 2 is a flowchart illustrating a method to compensate guide information according to an exemplary embodiment of the present general inventive concept.

The controlling unit 130 may control an photographable image to be displayed on a display, such as the display screen 190 or a display external to the photographing apparatus 100, in operation S210. The controlling unit 130 may determine whether or not a zoom-in area is designated, such as by determining whether or not part of the image displayed on the display screen 190 has been touched by a user in operation S220. It is understood that other methods of designating a zoom-in area by a user may be employed, such as moving a displayed cursor using the manipulation unit 170, and so on.

If it is determined that a zoom-in area is designated in operation S220, concentric circles of which the centers are located at the zoom-in area may be generated under the control of the controlling unit 130 in operation S230. These concentric circles are merely one example of the different types of guide information that may be displayed on the displayed image.

The controlling unit 130 may determine whether or not a zoom-in command is input by a user using the manipulation unit 170 in operation S240, and if it is determined that the zoom-in command is input in operation S240, the displayed image may be enlarged in response to the zoom-in command and the concentric circles may also be enlarged corresponding to the enlargement of the image under the control of the controlling unit 130 in operation S250.

The controlling unit 130 may determine whether or not an optical axis of the photographing apparatus 100 is changed, such as by hand-shaking, tilting, panning, and so on in operation S260, and may move the enlarged concentric circles on the screen according to the changed optical axis in operation S270.

FIGS. 3A to 3D are views illustrating a process of enlarging a displayed image and compensating the corresponding guide information. Referring to FIG. 3A, if part of the displayed image 310 is designated, for example, by being touched, and thus a zoom-in area is set by a user, information 320 representing the zoom-in area (herein referred to as zoom-in information 320) may be displayed on the part of the displayed image touched by a user under the control of the controlling unit 130.

If a zoom-in area is set, an optical axis 330 may be set together with the zoom-in area. Accordingly, although the optical axis 330 of the photographing apparatus 100 may have been changed by hand-shaking, tilting, panning, and so on, the zoom-in area may be recognized with reference to a preset optical axis 330. In doing so, neither the zoom-in area nor the zoom-in information 320 may be changed. As described above, although the zoom-in information 320 may not be changed, the optical axis 330 may be changed by hand-shaking, tilting, panning, and so on.

The controlling unit 130 may control the concentric circles 340 of which the centers are at the zoom-in area of the displayed image 310 to be displayed as guide information as illustrated in FIG. 3B.

If a zoom-in command is input by a user, the displayed image 310 may be enlarged, and the concentric circles 340 may also be compensated and thus the compensated concentric circles 340 may be displayed on the displayed image 310 under the control of the controlling unit 130 as illustrated in FIG. 3C. Thus, in a situation in which the optical axis 330 of the photographing apparatus 100 has been moved, a user can instinctively recognize the location of the center of the concentric circles 340 through the compensated concentric circles 340, and the center of the concentric circles 340 may allow the user to locate the zoom-in area. Accordingly, a user may perceive that the user should move the photographing apparatus 100 in a downward-left direction, in such as a case as that illustrated in FIG. 3C, in order to find the zoom-in area.

By doing so, a user may easily find the desired zoom-in area as illustrated in FIG. 3D. In FIG. 3D, the user has moved the photographing apparatus 100 until the optical axis 330 is located at the center of the compensated concentric circles 340, and thus has centered the optical axis 330 on the zoom-in area designated by the user before the enlargement of the displayed image 310.

The method to compensate the concentric circles 340 according to exemplary embodiments of the present general inventive concept may include a method to compensate concentric circles according to a zoom-in ratio using a normal vector, a method to compensate concentric circles by comparing an original displayed image with an enlarged image through image processing, other methods of comparison between the guide information and the displayed image, or any combination of these various methods.

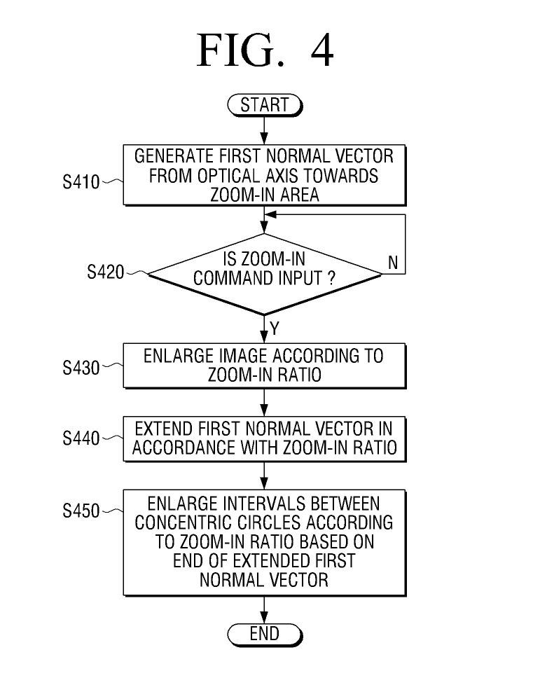

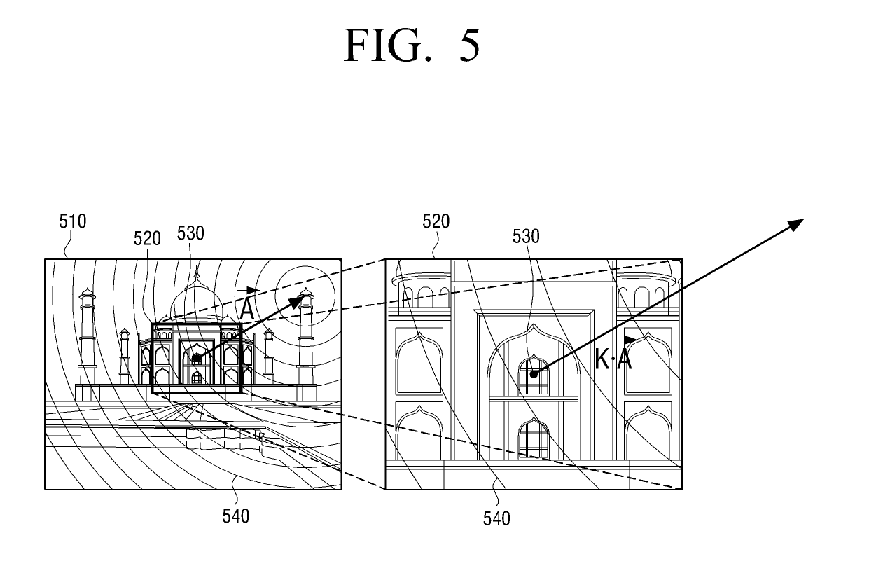

Hereinbelow, a method to compensate concentric circles according to a zoom-in ratio when a zoom-in command is input without changing an optical axis will be explained with reference to FIGS. 4 and 5.

FIG. 4 is a flowchart illustrating a method to compensate concentric circles when a zoom-in command is input. Assuming that a zoom-in area has already been set, the controlling unit 130 may generate a normal vector (herein referred to as the first normal vector) from an optical axis of the photographing apparatus 100 towards the zoom-in area in operation S410. The controlling unit 130 may determine whether or not a zoom-in command is input in operation S420, and if it is determined that the zoom-in command is input the controlling unit 130 may enlarge the displayed image according to the zoom-in ratio corresponding to the zoom-in command in operation S430.

The controlling unit 130 may extend the first normal vector which is generated in accordance with the zoom-in ratio in operation S440. For example, if a command to zoom-in an image by three times is input, the controlling unit 130 may extend the length of the pre-generated first normal vector by a factor of three.

The controlling unit 130 may enlarge intervals between the concentric circles according to the zoom-in ratio based on the zoom-in area having a center that is located at the ending point of the extended first normal vector in operation S450. For example, if the original first normal vector passes over five concentric circles, the controlling unit 130 enlarges the concentric circles so that the extended first normal vector also passes over five enlarged concentric circles. In other words, as both the first normal vector and the concentric circles may be enlarged according to the zoom-in ratio, and therefore are each enlarged by the same factor, the extended first normal vector should pass over the same number of enlarged concentric circles as the number of initial concentric circles that are passed over by the initial first normal vector.

To explain the above operation in more detail, FIG. 5 will be described. FIG. 5 is a view in which the first normal vector A is extended according to an exemplary embodiment of the present general inventive concept.

The left view of FIG. 5 illustrates an original displayed image 510 which is not enlarged yet, and the boundary of an enlarged displayed image 520 is indicated in the original image 510. That is, the left view of FIG. 5 illustrates both the original image 510 before the zoom-in command and the area of the enlarged image 520 that will be displayed after the zoom-in command.

The first normal vector A which extends from an optical axis 530 to a zoom-in area is displayed on the left view of FIG. 5, and the first normal vector A passes over five concentric circles 540. Specifically, if the distance between two adjacent concentric circles 540 is referred to as one portion, and the area enclosed by the centermost circle of the concentric circles 540 is also referred to as one portion, the first normal vector A passes over a total of approximately 5.5 portions.

In FIG. 5 the zoom-in ratio is represented by the factor K. Thus, if the user has requested that the displayed original image 510 is to be enlarged K times, the first normal vector A will correspondingly be enlarged to a length of K times A.

The right view of FIG. 5 illustrates the enlarged image 520, and the optical axis 530 and a portion of the extended first normal vector K·A are displayed on the enlarged image 520. Unlike the left view of FIG. 5, the zoom-in area is not indicated on the right view of FIG. 5 since the enlarged image 520 is displayed, and the enlarged image 520 has been enlarged to the extent that the zoom-in area has been moved outside the viewable portion of the enlarged image 520. That is, the zoom-in area is beyond the displayed portion of the enlarged image 520. Although the end of the extended first normal vector K·A is not displayed on the enlarged image 520, as the end also lies beyond the boundary of the enlarged image 520, it is illustrated in the right view of FIG. 5 to aid in the discussion of a virtual zoom-in area below.

In this situation, the photographing apparatus 100 may recognize a virtual zoom-in area which is not indicated on the displayed enlarged image 520 using the extended first normal vector K·A. That is, as the extended first normal vector K·A is formed in the same direction and at the same starting point (the optical axis 530) as those of the original first normal vector A, if the first normal vector A is enlarged as much as the zoom-in ratio K, the ending point of the extended first normal vector K·A may be determined.

Accordingly, the controlling unit 130 may recognize the virtual zoom-in area which is the center of the concentric circles 540.

The interval between the concentric circles 540 may be determined in addition to the zoom-in area which is the center of the concentric circles 540 in order to compensate the concentric circles 540 during the enlargement of the displayed image 510. That is, the shape of the concentric circles 540 (which are centered, as previously discussed, on the zoom-in area) may be recognized by detecting the zoom-in area, but this may not indicate the actual interval between the concentric circles 540.

Accordingly, the controlling unit 130 may determine the number of original concentric circles 540 over which the first normal vector A passes and may compensate the concentric circles 540 so that the number of enlarged concentric circles 540 over which the extended first normal vector K·A passes is the same as the number of the original concentric circles 540 over which the first normal vector A passes. Namely, as the first normal vector A passes over approximately 5.5 circles 540 on the original image 510, the controlling unit 130 may compensate the concentric circles 540 by enlarging the interval between the concentric circles 540 so that the extended first normal vector K·A passes over the same approximation of 5.5 enlarged concentric circles 540.

Accordingly, the right view of FIG. 5 is obtained. The first normal vector A illustrated in FIG. 5 is provided to easily explain this exemplary embodiment of the present general inventive concept, and the first normal vector may not be shown on the actual displayed image 510.

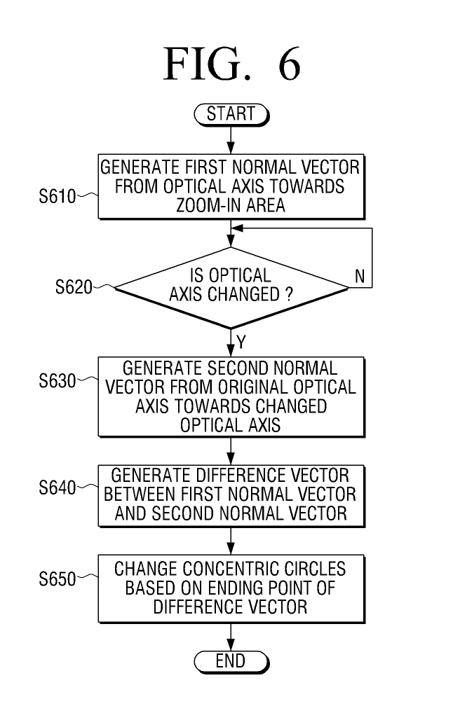

A method to compensate concentric circles when an optical axis is changed without a zoom-in command will be described with reference to FIGS. 6 to 8.

FIG. 6 is a flowchart illustrating a method to compensate concentric circles when an optical axis is changed. If a zoom-in area is set, the controlling unit 130 may generate the first normal vector from the optical axis towards the zoom-in area in operation S610. The controlling unit 130 may determine whether or not the optical axis is changed by hand-shaking, tilting, panning, and so on in operation S620, and if it is determined that the optical axis is changed the controlling unit 130 may generate a second normal vector from the original optical axis towards the changed optical axis in operation S630.

The controlling unit 130 may generate a difference vector between the first normal vector and the second normal vector in operation S640, and may compensate the concentric circles so that the concentric circles are generated based on the zoom-in area which is regarded as being centered upon the ending point of the difference vector in operation S650. In this situation, as the zoom-in command is not input, the concentric circles are compensated to have the same interval as that of the concentric circles existing before the optical axis was changed.

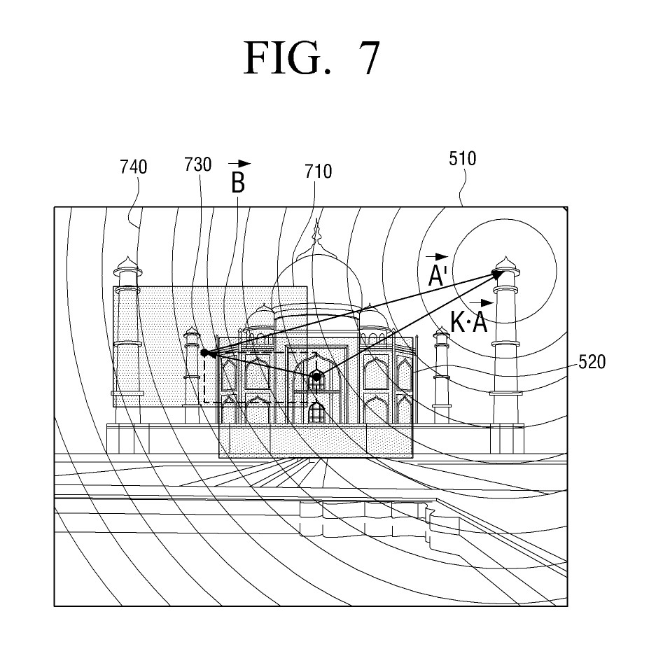

The operation discussed above will now be describe in more detail in reference to FIG. 7. FIG. 7 illustrates a displayed image 510 in which a difference vector A¹ is generated according to an exemplary embodiment of the present general inventive concept. Herein, it is supposed that the optical axis is changed from that of the enlarged image 520 illustrated in FIG. 5 for convenience of description. That is, suppose that the displayed image 510 of FIG. 5 is enlarged in response to a zoom-in command and thus an optical axis is changed, and in this situation, hand-shaking, tilting, panning, and so on occur.

If the optical axis 530 of the photographing apparatus 100 is changed to a current optical axis 730 before a zoom-in operation, a changed image 710 having the current optical axis 730 may be displayed on the photographing apparatus 100 after enlargement, instead of the previously discussed enlarged screen 520.

The controlling unit 130 may generate the second normal vector B from the original optical axis 530 towards the current optical axis 730, and the second normal vector B may be obtained by sensing the angular velocity of the photographing apparatus 100 through the motion sensor 160.

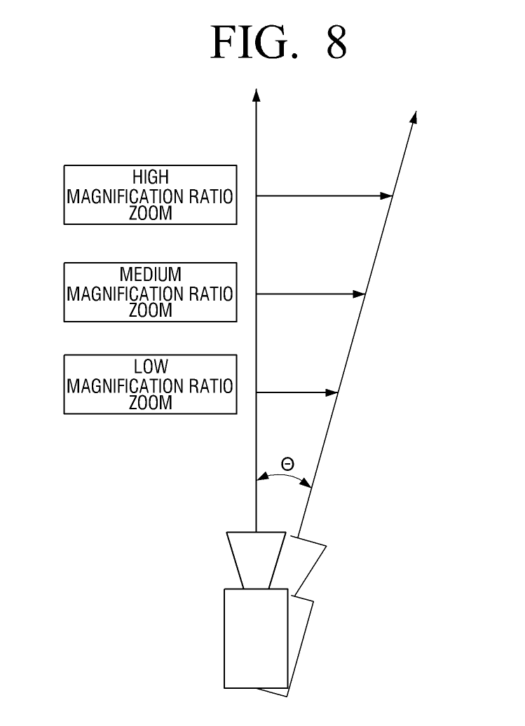

The above operation will be explained with reference to FIG. 8. FIG. 8 is a view illustrating a relationship between a zoom-in ratio and the second normal vector.

If the angular velocity of the photographing apparatus 100 is detected and thus an angle θ is obtained, the controlling unit 130 may determine the current magnification ratio of the photographing apparatus 100 and obtain the magnitude of the second normal vector B. In more detail the magnitude of the second normal vector B is proportional to the magnification ratio of the photographing apparatus 100, the controlling unit 130 can detect the magnitude of the second normal vector B with reference to the magnification ratio of the photographing apparatus 100.

Referring again to FIG. 7, the fact that the second normal vector B is generated means that it is possible to obtain the magnitude and direction of the second normal vector B. Accordingly, the controlling unit 130 may identify the original optical axis 530 using the magnitude and direction of the second normal vector B which are obtained through the current optical axis 730 and the generation of the second normal vector B that is made possible by obtaining the angle θ.

Accordingly, the controlling unit 130 may refer to the information regarding the originally recognized optical axis 530 to compensate the concentric circles.

As the image enlarged by the zoom-in command may be moved by hand-shaking, tilting, panning, and so on in this exemplary embodiment of the present general inventive concept, it is difficult to compensate the concentric circles using only the second normal vector. That is, in a case in which both the zoom-in operation and the optical axis change are performed, the first normal vector A described with reference to FIGS. 5 and 6 may also be required together with the second normal vector B in order to compensate the concentric circles, that is, in order to detect the zoom-in area.

In this situation, the zoom-in area is detected using the combination of the first and second normal vectors A,B as illustrated in FIG. 7. The numerical formula between the first normal vector A and the second normal vector B is represented as follows:

[Numerical Formula 1]

\vec{A}¹K·\vec{A}−\vec{B}

Herein, K represents the zoom-in ratio in accordance with the zoom-in command,

\vec{A} represents the first normal vector connecting the previous optical axis 530 and the zoom-in area,

\vec{B} represents the second normal vector connecting the previous optical axis 530 and the current optical axis 730, and

\vec{A}¹ represents the difference vector connecting the current optical axis 730 and the zoom-in area.

The controlling unit 130 may generate concentric circles of which the center is the zoom-in area to compensate the guide information.

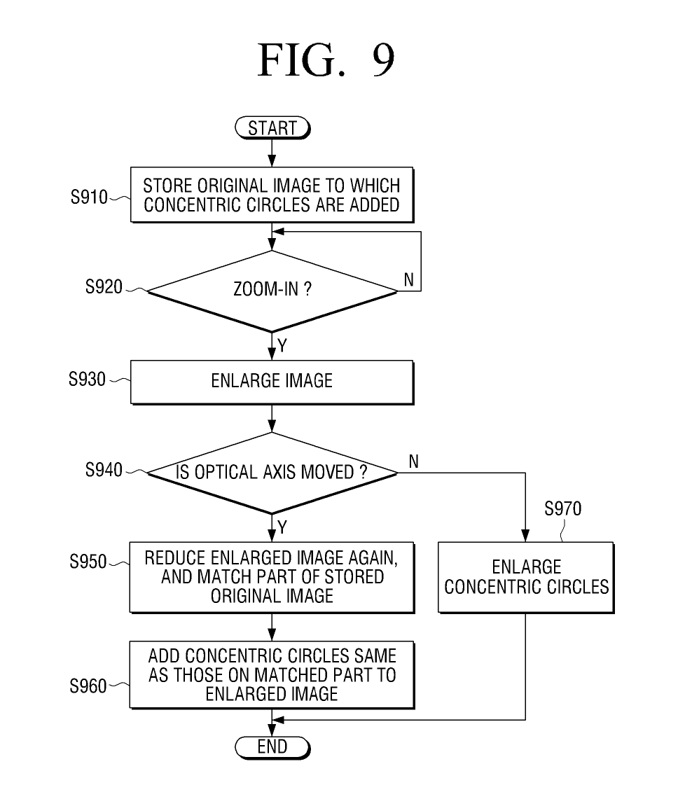

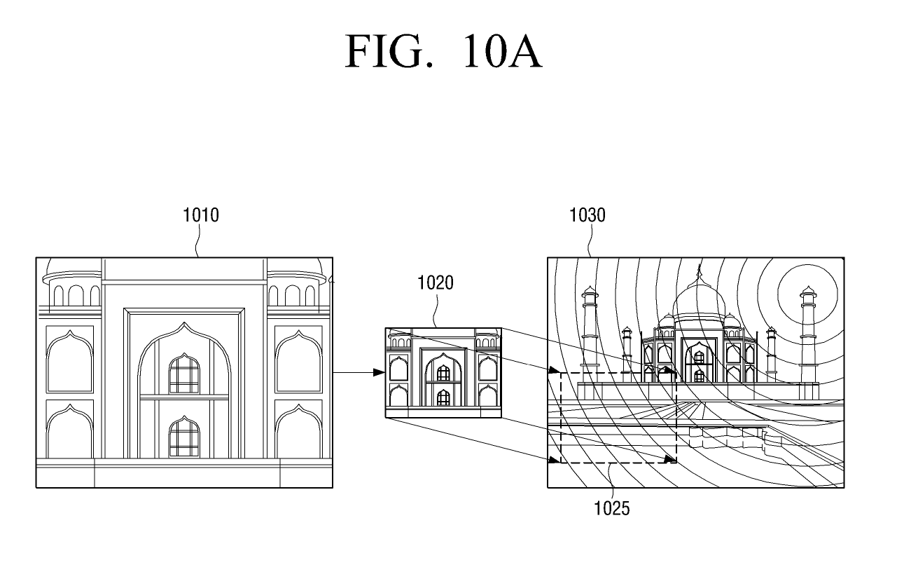

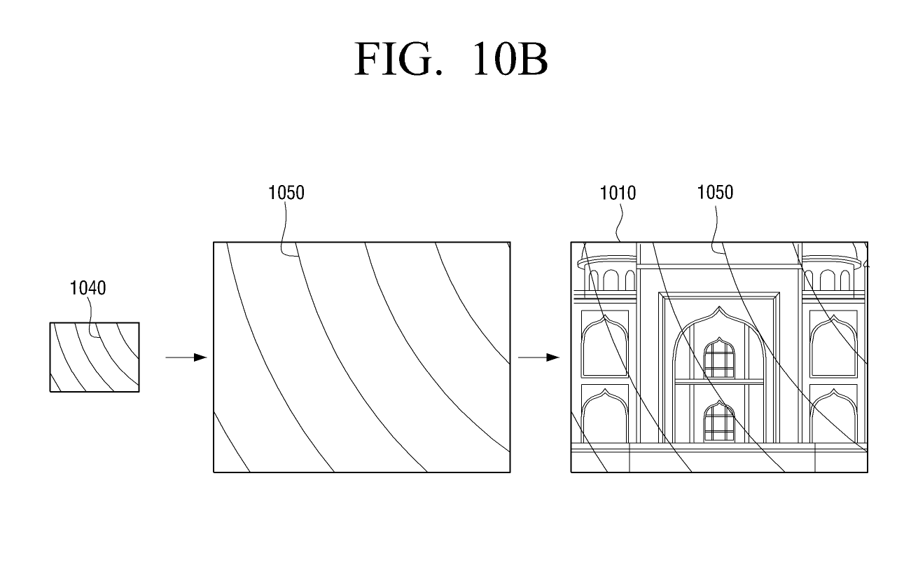

Herein, a method to compensate concentric circles by comparing an original image with an enlarged image through image processing will be explained with reference to FIGS. 9 to 10B.

FIG. 9 is a flowchart illustrating a method to compensate concentric circles through image processing. The controlling unit 130 may store the original image to which the concentric circles are added in the storage unit 150 in operation S910. The controlling unit 130 may determine whether or not a zoom-in command is input in operation S920, and if it is determined that the zoom-in command is input in operation S920, the controlling unit 130 may enlarge the original image and thus the enlarged image is generated in operation S930.

The controlling unit 130 may determine whether or not an optical axis is moved by the enlargement of the image in operation S940. If the optical axis is not moved despite the enlargement of the image, the zoom-in area has an optical axis that is identical to the optical axis of the original image. Generally, the zoom-in area does not have an optical axis that is identical to the optical axis, and thus if the zoom-in command is input, the image is enlarged and thus the optical axis may be moved.

If it is determined that the optical axis is moved in operation S940, the controlling unit 130 may reduce the enlarged image, and may search for the a matching part of the original image stored in the storage unit 150 in operation S950. In other words, the controlling unit 130 may reduce the enlarged image such that the size of the reduced image is the same size as that occupied in the original image by that reduced portion, in order to perform a search for that portion in the original image. As the reduced image which is generated by the reduction of the enlarged image may be part of the original image, the controlling unit 130 may search for the area of the original image matching the reduced image. In this situation, searching for the matching area may be performed in a manner of color matching in which colors of the images are compared, edge matching in which edges of the image are compared, and so on.

If an area of the reduced image which matches part of the original is detected, the controlling unit 130 may add the same concentric circles as those on the matched area to the reduced image, and may re-enlarge the reduced image having the added concentric circles in operation S960.

The operation of adding the concentric circles to the reduced image and then re-enlarging the reduced image having the added concentric circles is merely an exemplary embodiment of the present general inventive concept which has been discussed for convenience of description. Accordingly, the idea of the present general inventive concept may also be applied when the concentric circles displayed on the matched area are enlarged by the zoom-in ratio and the enlarged concentric circles are added to the enlarged image which has not been reduced.

If it is determined that the optical axis has not moved in operation S940, the controlling unit 130 may enlarge the concentric circles by the zoom-in ratio and may add the enlarged concentric circles to the enlarged image in operation S970 since the optical axis of zoom-in area is the same as that of the original image.

As described above, the concentric circles may be compensated by comparing the original image with the enlarged image using only the image processing without using a normal vector.

A more detailed description of this process will be discussed with reference to FIGS. 10A and 10B. FIGS. 10A and 10B are views in which concentric circles are compensated by reducing an enlarged image.

FIG. 10A illustrates views in which an enlarged image 1010 is reduced and thus a reduced image 1020 is generated, and then part of the original image 1030 corresponding to the reduced image 1020 may be searched for in the original image 1030. As a searched area 1025 is a part of the original image 1030, the searched area 1040 may include concentric circles. However, the controlling unit 130 may detect the matched area by comparing the original image 1030 not having the concentric circles with the reduced image 1020.

FIG. 10B illustrates views in which when the matched area is detected, concentric circles 1040 are extracted from the searched area, the extracted concentric circles 1040 are enlarged, the enlarged concentric circles 1050 are generated, and the enlarged concentric circles 1050 are added to the enlarged screen 1010.

By doing so, the concentric circles are accurately compensated only using the image processing without using a normal vector.

A method to compensate concentric circles using either a normal vector or image processing has been described. However, an exemplary embodiment of the present general inventive concept may also be applied to a method to compensate concentric circles using both a normal vector and image processing.

The method to compensate concentric circles using a normal vector is advantageous in that a normal vector may be obtained using a simple numerical formula, but disadvantageous in that this method may not be precise. The method to compensate concentric circles using image processing is advantageous in that concentric circles are accurately compensated, but disadvantageous in that if the optical axis of the enlarged screen or the optical axis of the screen having the changed optical axis is significantly apart from the optical axis of the original screen, or the original screen includes a moving object, errors may occur.

Accordingly, concentric circles may be precisely compensated by applying both the method using a normal vector and the method using image processing. When concentric circles are compensated by detecting a changed optical axis using a normal vector and then compensated by using image processing within the areas detected using the normal vector, the compensation may be effective in terms of accuracy and/or time.

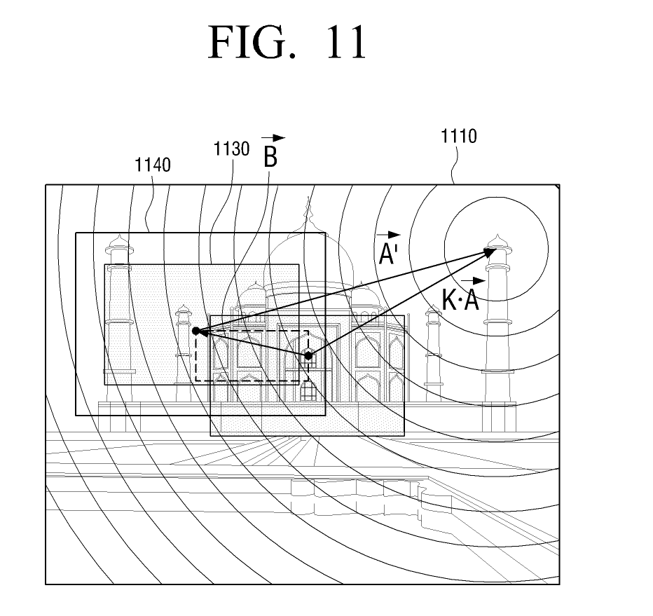

The above operation is illustrated in FIG. 11. FIG. 11 is a view in which concentric circles are compensated using both a normal vector and image processing.

As illustrated in FIG. 11, if a user inputs a zoom-in command to enlarge an original image 1110, and an influence such as hand-shaking, tilting, panning, etc., occurs at the same time the zoom-in command is input, the controlling unit 130 may extract a precise search area 1140 using a normal vector. The concentric circles may be compensated and added to a changed optical axis image 1130 which is enlarged within the precise search area 1140 using image processing under the control of the controlling unit 130.

While concentric circles may be provided as guide information in this exemplary embodiment of the present general inventive concept, the guide information is not limited to the concentric circles. The guide information may be an indicator such as an arrow indicating a zoom-in area, various borders or other symbols indicating the zoom-in area, etc., or a combination of such indicators.

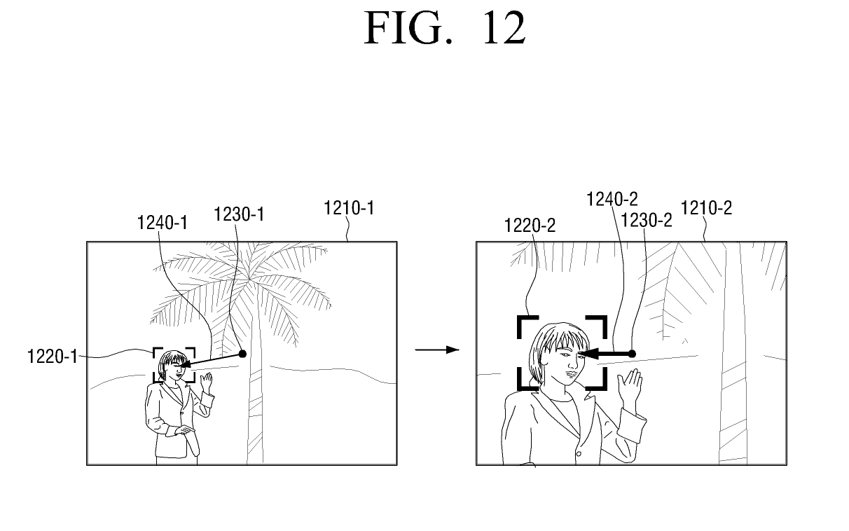

One alternate method is illustrated in FIG. 12. FIG. 12 is a view illustrating a method to enlarge an image using guide information represented by an arrowguide.

Referring to FIG. 12, if a user designates a zoom-in area 1220-1 on an original image 1210-1, information regarding an arrow guide 1240-1 from an optical axis 1230-1 to the zoom-in area 1220-1 may be generated. If the zoom-in command is input on the original image 1210-1, and influence such as hand-shaking, tilting, panning, etc., occurs at the same time the zoom-in command is input, an enlarged screen 1210-2 may be displayed.

The information regarding an arrow guide 1240-2 from a changed optical axis 1230-2 to a zoom-in area 1220-2 may be compensated and displayed on the enlarged image 1210-2. The arrow guide 1240-2 may be thicker and larger than the arrow guide 1240-1 on the original image 1210-1, and thus a user can recognize that the zoom-in area 1220-2 is closer.

The technical idea of the present general inventive concept may be applied when the size or thickness of arrow guide is changed. In other words, the previously discussed methods of enlarging the concentric circles may be applied to adjusting the size of the arrow guide so as to indicate the distance from a present optical axis to the zoom-in area selected by a user.

Designating a zoom-in area and enlarging an image has been thus far described in these various exemplary embodiments of the present general inventive concept, but the technical idea of the present general inventive concept may also be applied to designating a zoom-out area and reducing an image.

The guide information or the zoom-in information may be displayed on the displayed image as described in these various exemplary embodiments of the present general inventive concept, but additional information may also be displayed on the screen.

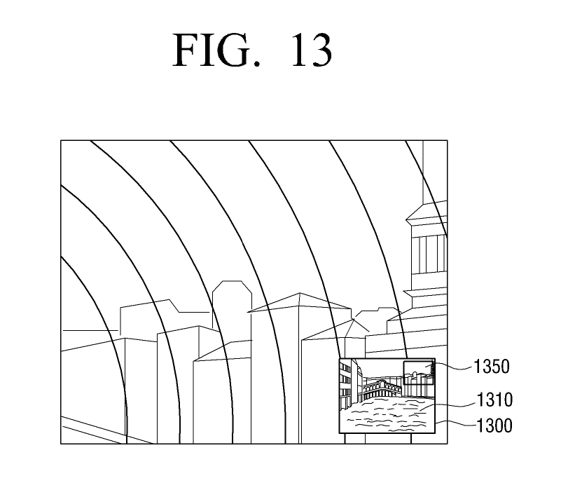

One such alternate method is illustrated in FIG. 13. FIG. 13 is a view in which a thumbnail image is displayed together with the guide information and the zoom-in information on a displayed image.

A thumbnail image 1300 is a type of additional information, and provides a user with information regarding the location and size of a currently displayed image 1350. A user may know the location of the currently displayed image 1350 in regard to an entire image 1310 and an approximate magnification ratio of the currently displayed image 1350.

Alternatively, guide information or zoom-in information may also be displayed on the thumbnail image 1300.

The thumbnail image 1300 has been thus far described as additional information in this exemplary embodiment of the present invention, but icons regarding guide information or zoom-in information and/or icons irrespective of the guide information or zoom-in information may also be displayed on the screen as additional information.

The photographable image displayed on the photographing apparatus may thus be enlarged, and a user can easily and conveniently access a desired object in the image.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A method to enlarge an image taken by an image capturing apparatus, the method comprising:
if a zoom-in area is designated on the image, adding guide information regarding the zoom-in area to the image,
if a zoom-in command is input, enlarging the image and compensating the guide information in response to the zoom-in command.

2. The method of claim 1, wherein the compensating the guide information includes enlarging the guide information according to a zoom-in ratio corresponding to the zoom-in command.

3. The method of claim 1, further comprising:
if an optical axis of the image capturing is changed, compensating the guide information based on information regarding the changed optical axis.

4. The method of claim 3, wherein the information regarding the changed optical axis comprises tilting information, panning information, hand-shaking information, or any combination thereof.

5. The method of claim 3, wherein the compensating the guide information comprises:
combining the information regarding the changed optical axis with a zoom-in ratio corresponding to the zoom-in command.

6. The method of claim 1, further comprising:
storing an image to which the guide information is added,
wherein the compensating the guide information includes matching a portion of the stored image with the enlarged image.

7. The method of claim 6, wherein the compensating the guide information comprises:
reducing or enlarging at least one of the enlarged image and the stored image and matching the enlarged image with the portion of the stored image; and
compensating the guide information to display guide information proportional to the guide information displayed on the portion of the stored image on the enlarged image.

8. The method of claim 1, wherein the guide information comprises a plurality of concentric circles of which the center is the zoom-in area, an indicator indicating the zoom-in area, or a combination thereof.

9. A method to change an image taken by an image capturing apparatus, the method comprising:
adding guide information regarding an area indicated on the image; and
changing the image and compensating the guide information using information regarding horizontal movement, vertical movement, or a combination thereof.

10. The method of claim 9, wherein the information regarding horizontal movement includes information regarding movement of the photographing apparatus that is parallel to a display screen of the photographing apparatus generated by tilting, panning, hand-shaking, or any combination thereof, and the information regarding vertical movement includes information regarding movement that is vertical to the display screen generated by at least one of zoom-in and zoom-out.

11. An image capturing apparatus, comprising:
a display unit to display an image; and
a controlling unit to add guide information regarding a zoom-in area to the image if the zoom-in area is designated on the image, and to enlarge the image and compensate the guide information in response to a zoom-in command being input.

12. The image capturing apparatus of claim 11, wherein the controlling unit enlarges and compensates the guide information according to a zoom-in ratio corresponding to the zoom-in command.

13. The image capturing apparatus of claim 11, further comprising:
a motion sensor to sense whether an optical axis of the image capturing apparatus is changed;
wherein the controlling unit compensates the guide information based on information regarding the changed optical axis.

14. The image capturing apparatus of claim 13, wherein the information regarding the changed optical axis comprises tilting information, panning information, hand-shaking information, or any combination thereof.

15. The image capturing apparatus of claim 13, wherein the controlling unit compensates the guide information by combining the information regarding the changed optical axis with a zoom-in ratio corresponding to the zoom-in command.

16. The image capturing apparatus of claim 11, further comprising:
a storage unit to store an image to which the guide information is added;
wherein the controlling unit compensates the guide information by matching a portion of the stored image with the enlarged image.

17. The image capturing apparatus of claim 16, further comprising:
an image processing unit to reduce or enlarge at least one of the enlarged image and the stored image,
wherein the controlling unit matches the enlarged image with the portion of the stored image, and displays guide information proportional to the guide information displayed on the portion of the stored image on the enlarged image.

18. The image capturing apparatus of claim 11, wherein the guide information comprises a plurality of concentric circles of which the center is the zoom-in area, an indicator indicating the zoom-in area, or a combination thereof.

19. A image capturing apparatus, comprising:
a display unit to display an image; and
a controlling unit to change the image and compensate guide information regarding an area indicated on the image using information regarding horizontal movement, vertical movement, or a combination thereof.

20. The image capturing apparatus of claim 19, wherein the information regarding horizontal movement includes information regarding movement of the image capturing apparatus that is parallel to a display screen of the image capturing apparatus generated by tilting, panning, hand-shaking, or any combination thereof, and the information regarding vertical movement includes information regarding movement that is vertical to the display screen generated by at least one of zoom-in and zoom-out.
